(19) United States
(12) Patent Application Publication
(10) Pub. No.: US 2026/0145498 A1
(43) Pub. Date: May 28, 2026

(54) Truck Bed Cover Mounting Frame

(71) Applicant: CHANGZHOU SUNWOOD INTERNATIONAL TRADING CO., LTD., Changzhou (CN)

(72) Inventors: Hang SHI, Changzhou (CN); Hongjuan ZHENG, Changzhou (CN)

(73) Assignee: CHANGZHOU SUNWOOD INTERNATIONAL TRADING CO., LTD., Changzhou (CN)

(21) Appl. No.: 19/001,451

(22) Filed: Dec. 25, 2024

(30) Foreign Application Priority Data
Nov. 22, 2024 (CN) 202422854018.X

(51) Int. Cl. B60J 7/14

(52) U.S. Cl. CPC B60J 7/141

(57) ABSTRACT

A truck bed cover mounting frame relates to the technical field of truck bed covers. The truck bed cover mounting frame includes a frame body, a clamping assembly connected to the frame body, and a connecting structure, where the clamping assembly is clamped to at least one side of a front panel of a truck bed; and the connecting structure is configured to fixedly connect the frame body to a cover. The mounting frame of the present disclosure is provided on the front panel of the truck bed, saving the mounting space of side rails and reducing the load on the side rails.

### CROSS REFERENCE TO THE RELATED APPLICATIONS

This application is based upon and claims priority to Chinese Patent Application No. 202422854018.X, filed on Nov. 22, 2024, the entire contents of which are incorporated herein by reference.

### TECHNICAL FIELD

The present disclosure relates to the technical field of truck bed covers, and in particular to a truck bed cover mounting frame.

### BACKGROUND

The hard cover of a truck bed generally adopts a folding or rolling structure, and the cover (or called front panel) close to the cab is usually fixedly connected to the truck bed. In the prior art, the cover is generally fixedly connected to the left and right side rails of the truck bed, which occupies the mounting space of the side rails and increases the load on the side rails.

### SUMMARY

In order to solve the problem that the cover in the prior art is provided on the side rails, occupying the mounting space of the side rails, the present disclosure provides a truck bed cover mounting frame. In the present disclosure, the cover is provided on the front panel of the truck bed, reducing space occupation on the side rails.

In order to solve the above technical problem, the present disclosure adopts the following technical solution.

A truck bed cover mounting frame includes:
a frame body;
a clamping assembly, connected to the frame body and clamped to at least one side of a front panel of a truck bed; and
a connecting structure, configured to fixedly connect the frame body to a cover.

Furthermore, the clamping assembly includes a mounting element and a first bolt of the mounting element connected to the frame body; a length direction of the first bolt is parallel to a thickness direction of the front panel of the truck bed; and the first bolt is configured to apply a force to allow the mounting element to be tightly adhered to the at least one side of the front panel of the truck bed.

In an embodiment of the present disclosure, the mounting element include a first mounting element and a second mounting element that are respectively clamped to two sides of the front panel of the truck bed; the first mounting element is fixedly connected to the frame body; and the first bolt is threaded to the frame body and abuts against the second mounting element.

Furthermore, the first mounting element and/or the second mounting element are provided with an inner flange that is matched with the front panel of the truck bed in terms of shape. The inner flange further restricts the up and down movement of the mounting frame, improving the overall stability of the mounting frame.

Furthermore, the second mounting element is provided with a limit groove for accommodating the first bolt. The first bolt is inserted into the limit groove. The design achieves easy mounting and restricts the movement of the second mounting element, thereby achieving good overall stability.

In another embodiment of the present disclosure, the first bolt is threaded to the frame body; the mounting element includes a first clamping element; and the first clamping element is clamped to a front side of the front panel of the truck bed.

In another embodiment of the present disclosure, the mounting element includes a second clamping element, and the second clamping element is clamped to a rear side of the front panel of the truck bed.

Furthermore, an inner side of the front panel of the truck bed is provided with a slot, and the second clamping element is embedded in the slot; and the first bolt passes through the frame body and is threaded to the second clamping element.

Furthermore, the mounting frame is provided with a through hole; the connecting structure includes a second bolt embedded in the cover; and the second bolt passes through the through hole and is threaded to a second nut.

Furthermore, the through hole is a kidney shaped hole; and a length direction of the kidney shaped hole is parallel to a length direction of the truck bed. The through hole is set as a kidney shaped hole, leaving room for adjusting the mounting position of the cover.

### Beneficial Effects

(1) The mounting frame of the present disclosure is provided on the front panel of the truck bed, reducing the load on side rails and saving the mounting space of the side rails.

(2) The fixed bracket provided on the front panel of the truck bed also provides some support for the cover. Therefore, the front, left, and right sides of the cover can be supported, with good support effect and more uniform force distribution.

(3) The truck bed cover mounting frame of the present disclosure is clamped and fixed through a bolt and thread connection method, which is convenient for implementation and mounting operation, and has low cost.

### BRIEF DESCRIPTION OF THE DRAWINGS

To describe the technical solutions in the embodiments of the present disclosure more clearly, the following briefly introduces the drawings required for describing the embodiments. Apparently, the drawings in the following description show merely some embodiments of the present disclosure, and those of ordinary skill in the art may still derive other drawings from these drawings without creative efforts.

FIG. 1 is a schematic diagram of an external mounting position of a truck bed cover mounting frame according to Embodiment 1;

FIG. 2 is a schematic diagram of a mounting section of the truck bed cover mounting frame according to Embodiment 1;

FIG. 3 is a structural diagram of the truck bed cover mounting frame according to Embodiment 1;

FIG. 4 is a first three-dimensional structural diagram of the truck bed cover mounting frame provided on a front panel of a truck bed according to Embodiment 1;

FIG. 5 is a second three-dimensional structural diagram of the truck bed cover mounting frame provided on the front panel of the truck bed according to Embodiment 1;

FIG. 6 is an internal structural diagram for mounting of the truck bed cover mounting frame according to Embodiment 1;

FIG. 7 is a structural diagram of a second mounting element;

FIG. 8 is a structural diagram for mounting of the truck bed cover mounting frame according to Embodiment 2.

FIG. 9 is a schematic diagram of a mounting position of a second clamping element according to Embodiment 3;

FIG. 10 is a structural diagram of the truck bed cover mounting frame according to Embodiment 3; and

FIG. 11 is an exploded view of the truck bed cover mounting frame according to Embodiment 3.

Reference Numerals: 1. frame body; 21. first mounting element; 211. inner flange; 22. second mounting element; 221. limit groove; 23. first clamping element; 24. second clamping element; 3. first bolt; 4. first nut; 5. through hole; 6. second bolt; 7. second nut; 8. front panel; 81. slot; and 9. cover.

### DETAILED DESCRIPTION OF THE EMBODIMENTS

The technical solutions in embodiments of the present disclosure will be described below clearly and completely with reference to the accompanying drawings in the embodiments of the present disclosure. Apparently, the described embodiments are merely some, rather than all of the embodiments of the present disclosure. The following description of at least one exemplary embodiment is merely illustrative, and not intended to limit the present disclosure and application or use thereof in any way. All other embodiments obtained by those of ordinary skill in the art based on the embodiments of the present disclosure without creative efforts shall fall within the protection scope of the present disclosure.

It should be noted that the terminology used herein is for the purpose of describing particular embodiments only and is not intended to limit exemplary embodiments according to the present disclosure. As used herein, unless otherwise specified herein, the singular forms are also intended to include the plural forms. In addition, it should also be understood that when the terms “comprise” and/or “include” are used in this specification, they specify the presence of features, steps, operations, devices, components, and/or combinations thereof.

The relative arrangement of the components and steps, the numerical expressions and numerical values set forth in these embodiments do not limit the scope of the present disclosure unless specifically stated otherwise. Meanwhile, it should be understood that for ease of description, each portion in the drawings is not necessarily drawn to the actual scale. The technologies, methods, and devices known to those of ordinary skill in the art may not be discussed in detail, but where appropriate, the technologies, methods, and devices should be regarded as part of the specification. In all examples shown and discussed herein, any specific value should be interpreted as merely exemplary, rather than restrictive. Therefore, other examples of the exemplary embodiments may have different values. It should be noted that similar reference signs and letters represent similar items in the drawings below. Therefore, once an item is defined in one drawing, it does not need to be further discussed in subsequent drawings.

It should be understood that in the description of the present disclosure, orientation terms such as “front”, “rear”, “upper”, “lower”, “left”, “right”, “transverse”, “longitudinal”, “vertical”, “horizontal”, “top”, and “bottom” indicate orientation or position relationships based on the drawings. Unless otherwise specified, these orientation terms are merely intended to facilitate or simplify the description of the present disclosure, rather than to indicate or imply that the mentioned device or elements must have a specific orientation and must be constructed and operated in a specific orientation. Therefore, they should not be construed as a limitation to the protection scope of the present disclosure. The orientation terms “inner” and “outer” refer to the inner and outer parts relative to the contour of the mentioned component.

For ease of description, spatially relative terms, such as “above”, “on the upper side of”, “on the upper surface of” and “on”, can be used to describe the spatial positional relationship between components or features shown in the figure. It should be understood that the spatially relative terms are intended to encompass different orientations of the components in use or operation in addition to those shown in the figure. For example, if a component in the figure is inverted, it is described as a component “above other component or structure” or “on other component or structure”. Therefore, the component will be positioned as “below other component or structure” or “under other component or structure”. Therefore, the exemplary term “above” may include both orientations “above” and “below”. The component may also be positioned in other different ways (rotated by 90 degrees or in other orientations), but the relative description of the space should be explained accordingly.

In addition, it should be noted that the use of words such as “first” and “second” to define parts and components is only for the convenience of distinguishing corresponding parts and components. Unless otherwise stated, the above words have no special meaning, so they should not be construed as a limitation on the protection scope of the present disclosure.

The present disclosure provides a truck bed cover mounting frame, including frame body 1, a clamping assembly connected to the frame body 1, and a connecting structure. The clamping assembly is clamped to at least one side of front panel 8 of a truck bed. The connecting structure is configured to fixedly connect the frame body 1 to cover 9.

The clamping assembly includes a mounting element and first bolt 3 of the mounting element connected to the frame body 1. A length direction of the first bolt 3 is parallel to a thickness direction of the front panel 8 of the truck bed. The first bolt 3 applies a force to allow the mounting element to be tightly adhered to the at least one side of the front panel 8 of the truck bed. Of course, for buffering or protection reasons, an intermediate component such as a rubber gasket can be provided between the mounting element and the front panel 8 of the truck bed.

### EMBODIMENT 1

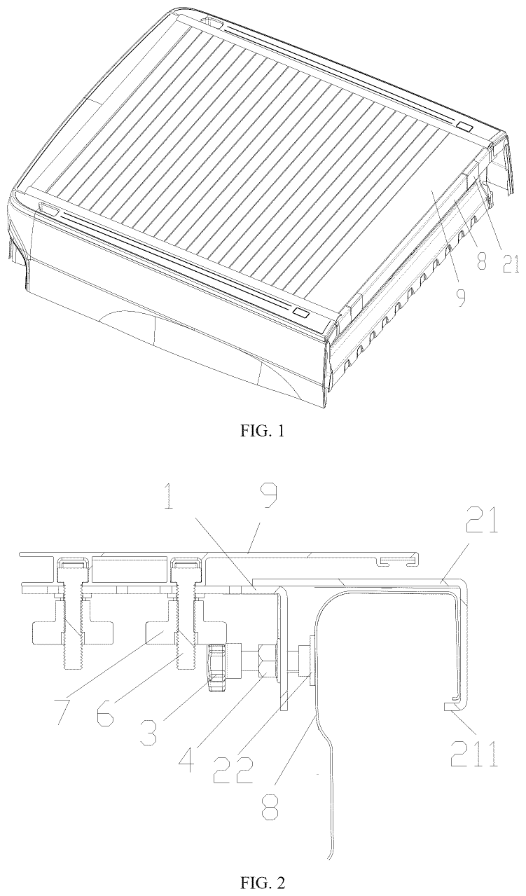

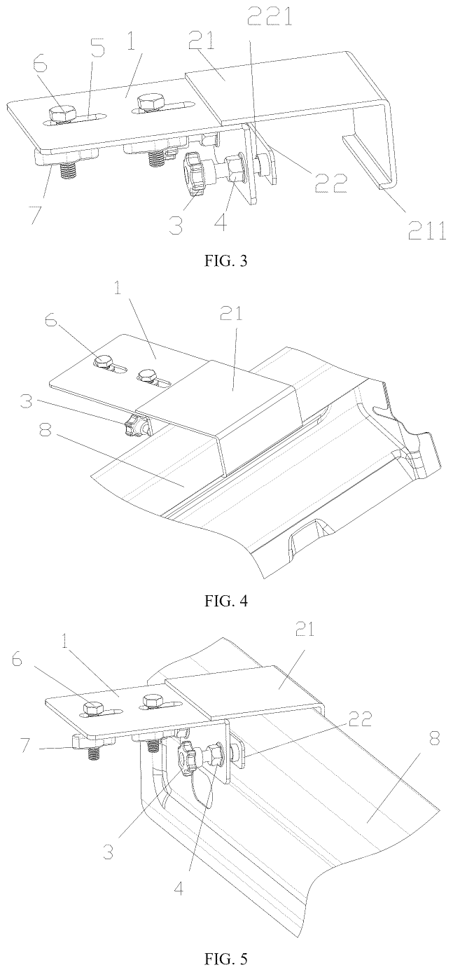

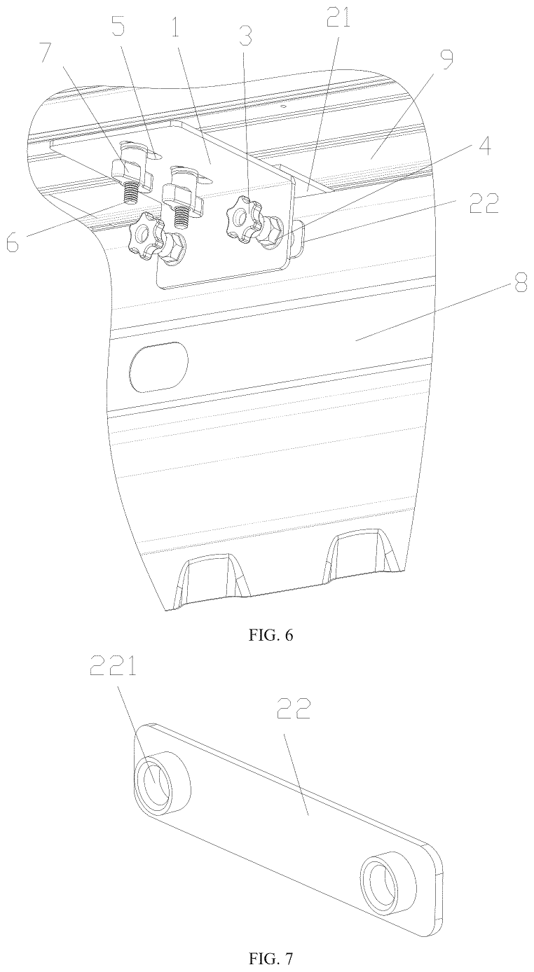

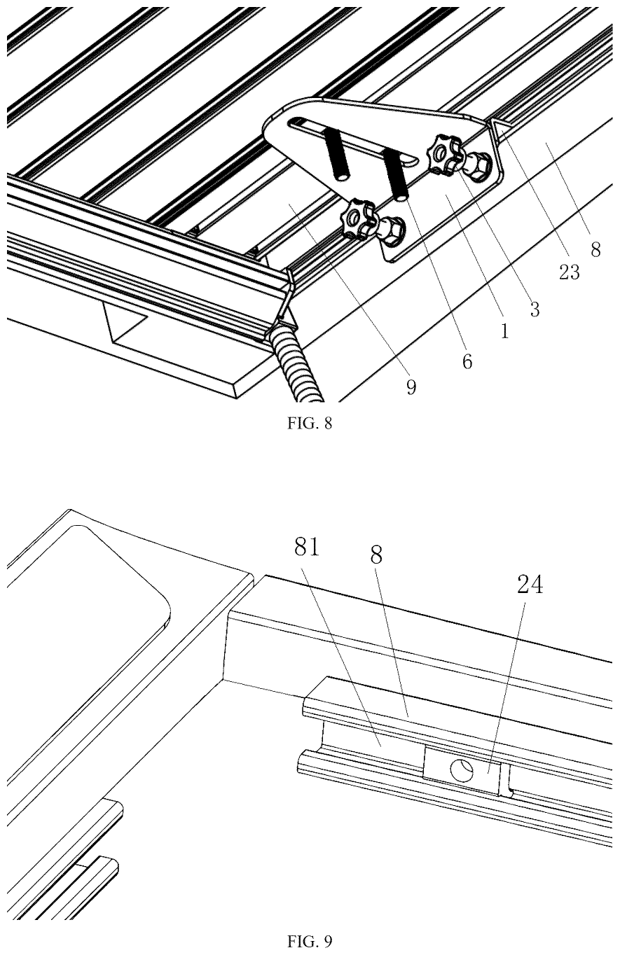

As shown in FIGS. 1 to 7, the mounting element include first mounting element 21 and second mounting element 22 that are respectively clamped to two sides of the front panel 8 of the truck bed. The first mounting element 21 is fixedly connected to the frame body 1. The connection method is alternative but not limited to welding. The first bolt 3 is threaded to the frame body 1 and abuts against the second mounting element 22. Specifically, the frame body 1 is fixed with first nut 4. The first nut 4 is fixed to the frame body 1 through a method that is alternative but not limited to welding. The first bolt 3 is in a threaded fit with the first nut 4. The first bolt 3 can adjust a distance between the first mounting element 21 and the second mounting element 22 to adapt to different thicknesses of the front panel 8 of the truck bed. Meanwhile, the first bolt 3 can tighten the first mounting element 21 and the second mounting element 22 to each other, thereby clamping the first mounting element 21 and the second mounting element 12 respectively at the two sides of the front panel 8 of the truck bed. That is, the first mounting element 21 and the second mounting element 22 form a clamp assembly as a whole, which is clamped on the front panel 8 of the truck bed. In general, the mounting frame can be fixed to the front panel 8 of the truck bed solely by a clamping force. Preferably, the first mounting element 21 and/or the second mounting element 22 are provided with an inner flange that is matched with the front panel 8 of the truck bed in terms of shape. The inner flange restricts the up and down movement of the mounting frame, thereby enhancing the overall stability of the mounting frame. In the embodiment of the present disclosure, the inner flange 211 is provided on the first mounting element 21. The first mounting element 21 is provided at upper and front sides of the front panel 8 of the truck bed. The inner flange 211 is configured to fasten a side of the front panel 8 of the truck bed facing downward. The second mounting element 22 is provided at a rear side of the front panel 8 of the truck bed. The cover of the present disclosure can be a front cover close to the cab, which can be provided through two or more mounting frames as needed.

In order to facilitate the positioning of the second mounting element 22, the second mounting element 22 is provided with limit groove 221 for accommodating the first bolt 3. In this way, during mounting, first, a head of the first bolt 3 is inserted into the limit groove 221, and then the first bolt 3 is tightened to facilitate the adjustment of clamping force.

The connecting structure between the mounting frame and the cover 9 is alternative but not limited to clamping or locking. In the preferred embodiment of the present disclosure, the mounting frame is provided with through hole 5. The connecting structure includes second bolt 6 embedded in the cover 9. The second bolt 6 passes through the through hole 5 and is threaded to a second nut 7. The second nut 7 is alternative but not limited to a butterfly nut. Preferably, the through hole 5 is a kidney shaped hole. A length direction of the kidney shaped hole is parallel to a length direction of the truck bed. A width direction of the kidney shaped hole is adapted to a diameter of the second bolt 6. The design achieves the limit of the width direction of the cover 9 and the position adjustment of the length direction of the cover 9.

A mounting process is as follows. The limit groove 221 of the second mounting element 22 is fitted onto the first bolt 3. The first bolt 3 is adjusted such that the distance between the first mounting element 21 and the second mounting element 22 is greater than the thickness of the front panel 8 of the truck bed. The mounting frame is placed as a whole on the front panel 8 of the truck bed. The first mounting element 21 and the second mounting element 22 are respectively clamped to the two sides of the front panel 8 of the truck bed. The first bolt 3 is adjusted to reduce the distance between the first mounting element 21 and the second mounting element 22. Thus, the first mounting element 21 and the second mounting element 22 gradually clamp the front panel 8 of the truck bed, completing the mounting of the mounting frame. When the cover 9 closes the truck bed, the second bolt 6 passes through the kidney shaped hole, and the second nut 7 fixes the cover 9 to the mounting frame.

### EMBODIMENT 2

As shown in FIG. 8, the first bolt 3 is threaded to the frame body 1. The mounting element includes first clamping element 23. The first clamping element 23 is clamped to the front side of the front panel 8 of the truck bed. In this embodiment, the first clamping element 23 directly cooperates with the first bolt 3 to clamp the front panel 8 of the truck bed. That is, the first clamping element 23 is clamped to an outer side of the front panel 8 of the truck bed, and the first bolt 3 is abuts against an inner side of the inner wall 8 of the truck bed. In other words, Embodiment 2 eliminates the second mounting element 22 of Embodiment 1, with the rest being the same as that of Embodiment 1.

### EMBODIMENT 3

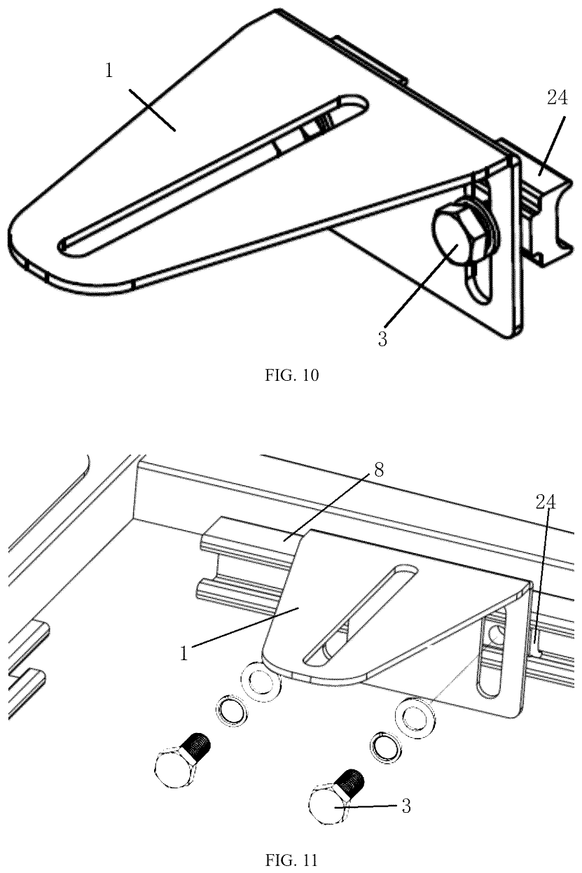

As shown in FIGS. 9 to 11, the mounting element includes second clamping element 24, and the second clamping element 24 is clamped to a rear side of the front panel 8 of the truck bed. In an implementation, an inner side of the front panel 8 of the truck bed is provided with slot 81, and the second clamping element 24 is embedded in the slot 81. The first bolt 3 passes through the frame body 1 and is threaded to the second clamping element 24. In this embodiment, a gasket or other structure can also be provided between the first bolt 3 and the frame body 1. A front side of the slot 81 is open to facilitate the fit between the first bolt 3 and the second clamping element 24. A front wall of the slot 81 abuts against the second clamping element 24 and achieves the limit of the second clamping element 24.

### EMBODIMENT 4

The mounting frame of the present disclosure can be attached to the front panel 8 of the truck bed through other methods, in addition to the above clamping method. In order not to alter the structure of the truck bed itself, the existing truck bed structure is utilized as much as possible. For example, the bolt on the front panel 8 of the truck bed is used, the frame body is fixed or integrally formed with a clamping plate that is matched with the inner side surface and/or outer side surface of the front panel of the truck bed. The bolt of the front panel 8 of the truck bed can pass through the clamping plate (if necessary, the bolt size can be increased) to abut the clamping plate against the inner and outer side surfaces and/or outer side surface of the front panel 8 of the truck bed, thereby fixing the mounting frame to the front panel 8 of the truck bed.

The above merely describes specific implementations of the present disclosure, but the protection scope of the present disclosure is not limited thereto. Those skilled in the art can easily conceive modifications or replacements according to the technical solutions and ideas of the present disclosure within the technical scope of the present disclosure, and these modifications or replacements shall fall within the protection scope of the present disclosure.

1. A truck bed cover mounting frame, comprising:
a frame body;
a clamping assembly, connected to the frame body and clamped to at least one side of a front panel of a truck bed; and
a connecting structure, configured to fixedly connect the frame body to a cover.

2. The truck bed cover mounting frame according to claim 1, wherein the clamping assembly comprises a mounting element and a first bolt of the mounting element connected to the frame body; a length direction of the first bolt is parallel to a thickness direction of the front panel of the truck bed; and the first bolt is configured to apply a force to allow the mounting element to be tightly adhered to the at least one side of the front panel of the truck bed.

3. The truck bed cover mounting frame according to claim 2, wherein the mounting element comprise a first mounting element and a second mounting element, wherein the first mounting element and the second mounting element are respectively clamped to two sides of the front panel of the truck bed; the first mounting element is fixedly connected to the frame body; and the first bolt is threaded to the frame body and abuts against the second mounting element.

4. The truck bed cover mounting frame according to claim 3, wherein the first mounting element and/or the second mounting element are provided with an inner flange, wherein the inner flange is matched with the front panel of the truck bed in terms of shape.

5. The truck bed cover mounting frame according to claim 4, wherein the second mounting element is provided with a limit groove for accommodating the first bolt.

6. The truck bed cover mounting frame according to claim 2, wherein the first bolt is threaded to the frame body; the mounting element comprises a first clamping element; and the first clamping element is clamped to a front side of the front panel of the truck bed.

7. The truck bed cover mounting frame according to claim 2, wherein the mounting element comprises a second clamping element, and the second clamping element is clamped to a rear side of the front panel of the truck bed.

8. The truck bed cover mounting frame according to claim 7, wherein an inner side of the front panel of the truck bed is provided with a slot, and the second clamping element is embedded in the slot; and the first bolt passes through the frame body and is threaded to the second clamping element.

9. The truck bed cover mounting frame according to claim 1, wherein the mounting frame is provided with a through hole; the connecting structure comprises a second bolt embedded in the cover; and the second bolt passes through the through hole and is threaded to a second nut.

10. The truck bed cover mounting frame according to claim 9, wherein the through hole is a kidney shaped hole; and a length direction of the kidney shaped hole is parallel to a length direction of the truck bed.
